(19) United States
(12) Patent Application Publication
(10) Pub. No.: US 2023/0273129 A1
(43) Pub. Date: Aug. 31, 2023

(54) GOLD NANOPARTICLES FOR BIO-MOLECULE DETECTION IN BODY FLUID AND SYSTEMS THEREFOR

(71) Applicant: QuikSudor Diagnostics LLC, Katy, TX (US)

(72) Inventors: Xun Samuel GUO, Katy, TX (US); Sheng XU, Richmond, TX (US)

(21) Appl. No.: 17/681,852

(22) Filed: Feb. 28, 2022

(51) Int. Cl. G01N 21/65; C01G 7/00

(52) U.S. Cl. CPC G01N 21/658; C01G 7/00; G01N 2201/06113

(57) ABSTRACT

This invention provides gold nanoparticles for bio-molecule detection in body fluid and systems therefor. In one embodiment, this invention provides a method for synthesis of gold nanoparticles dispersed in solution. In another embodiment, this invention provides a method for detecting a substance directly from a sample of body fluid with SERS using the gold nanoparticles dispersed in solution. In a further embodiment, this invention provides a system, having the gold nanoparticles dispersed in solution, for on-site detection of a substance directly from a sample of body fluid with SERS.

### FIELD OF THE INVENTION

The present invention relates to the field of bio-medical diagnostics.

### BACKGROUND OF THE INVENTION

Since its development over 40 years ago, surface enhanced Raman spectroscopy (SERS) has now become an enabling spectroscopic tool in chemical, material, and life sciences. Raman spectroscopy is based on detection of the unique vibration modes of molecules, i.e. the fingerprints of the analyte. The surface enhanced Raman spectroscopy uses metallic particles (Au, Ag) in nanoscale to greatly enhance the Raman signal, up to 10 orders of magnitude [1]. Studies found that the enhanced Raman signals originated from the optical excitation of collective oscillations of the electrons in the metallic nanosized features at the surface [2]. The high sensitivity of SERS leads to chemical recognition at even a single molecule level [3].

The advantages of SERS include [4], (a) recognition capabilities, owing to the vibrational fingerprints of molecules; (b) non-destructive analysis; (c) minimum preparation of the sample required; (d) possibility of carrying out measurements in biological fluids, since the water spectrum is rather weak; (e) simultaneous detection of different analytes (multiplexing); (f) possibility of carrying out on-site analysis with portable instruments [5], with high sensitivity.

Studies found that, in order to amplify the Raman signals for detection, gaps between analytes and nano-particles (NPs) need to be controlled within an optimal range [4], in addition to optimizing the size and shape of the nanoparticles. Thus, an important prerequisite for SERS applications in chemical analyses and detections is the development of highly reproducible and reliable substrates [6]. The substrates also need to have quasi-uniform and predictable optical and near-field properties.

The choice of the substrate type, material, and fabrication method depend on the specific applications. Several types of substrates for direct analyte detections have been developed, including aggregated nanoparticles in solution [7]-[20], nanoparticles assembled on a surface [21], and ordered arrays of nanoparticles [22]-[23].

Spherical silver and gold colloids are the most widely used nanoparticles for SERS experiments in solution. They are often synthesized by reduction of a precursor salt with sodium citrate in water; the citrate adsorbed on the surface of the nanoparticles acts also as an electrostatic stabilizer [19]-[20]. Moreover, in addition to spherical nanoparticles, several different shapes have been developed in order to cover a broader spectral range and to improve their SERS enhancing properties including spheres, rods, cubes, pyramids, plates, wires, corals, stars, etc. [7]-[20].

A very efficient method for increasing the SERS signal relies on the aggregation of the nanoparticles. For example, it can be carried out by adding a salt (i.e., NaCl, NaNO3, etc.) to the solution. Methods to improve the repeatability of SERS based on the aggregation of colloidal nanoparticles have been proposed in some papers [24]-[25]. The use of aggregated nanoparticles in solution is a very practical method for SERS detection, which exploits easily synthesizable (or even commercial) materials and, under suitable conditions, provides very strong enhancements.

As a spectroscopic tool, SERS has been extensively applied to bio-medical areas, for species identification and quantification. Pilot, R. et al. [4] recently reviewed and summarized a comprehensive list of various bio-medical applications. SERS has also been used for the detection of food additives or contaminants [26]-[29], explosives and warfare agents [30], in forensic science [31], and to monitor reactions catalyzed by metallic surfaces [32] or nanoparticles [33].

Furthermore, SERS technology has been applied for identification and quantification of chemicals from human body fluids for diagnostics and health care purposes. M. B. Mamian-Lopez et al. has used SERS for nicotine detection from urine [34]. J. L. Flores-Guerrero et al. has used Raman spectroscopy for urinary albumin excretion on Type 2 diabetes patients. Y-C Kao et al. reported to use multiplex SERS to identify and quantify 4-mercaptophenylboronic acid from urine within 30 minutes [35]. D. Lin, et. al, reported to use SERS on human blood for a label-free tumor stage detection for cancer diagnostics [36]. However, so far there has been no publication of SERS spectroscopy for bio-chemical detections through sweat.

Main content of sweat is water (˜99%) [37]; it also contains other small amounts of substances including nitrogenous compounds such as amino acids and urea [38], metal and nonmetal ions such as potassium, sodium, and chloride ions [39], metabolites including lactate and pyruvate, and xenobiotics such as drug molecules [37].

Sweat has been used as a medium for the detection of various drugs [40], and doping control [41], based on the assumption that a small but significant amount of drug is excreted in sweat [42]. Drugs are generally incorporated into sweat by passive diffusion because of a concentration gradient in which only the free fraction of drug (unbound to proteins) diffuses through lipid membranes from plasma to sweat [42]. Due to the presence of very nominal impurities, the sample preparation of sweat is very easy as compared with other biofluids. In addition, sweat samples are less prone to adulterations; thus such samples can be stored for long periods. Unlike blood, sweat possesses excellent features including its noninvasive sampling. Owing to this characteristic, sweat analysis is considered as a rapid and easy process in comparison to other biofluids, especially blood [40].

So far, sweat analysis for screening of drug abuse can be accomplished through a few approaches. First methodology involves an immunochromatographic testing (for example, Drug Screen Cartridge by Intelligent Fingerprinting Ltd, UK) for qualitative detection of recently used drugs involving sweat sample collected at single time point for identifying the individuals who are under the effect of drugs [43]. Another methodology involves a sweat patch technology for qualitative detection of previously used drugs involving sweat sample collected at single time point for the follow-up of drug users under treatment to substantiate abstinence (for example, PharmChek® Sweat Patch) [44].

With the instrumental development of Raman Spectrometer (RS), hand-held RS devices become widely available on the market. This enables the possibility of rapid on-site bio-molecule detection through SERS using a hand-held RS [45]. However, the use of such method for the high-sensitivity detection of bio-molecules, in particular methamphetamine, on fingerprint sweat has yet to be disclosed.

Triplett et al. [46] disclosed the use of both regular Raman spectroscopy and SERS with gold colloid solutions for the screening of methamphetamine in clandestine laboratory liquids. The test samples used ethanol, diethyl ether and Coleman fuel as the solvents to dissolve the methamphetamine, as they were frequently used in illicit manufacturing of methamphetamine. However, it was found that the Raman band for the methamphetamine at approximately 1003 cm-1 was only discernable down to approximately 4% w/v, which is equivalent to 40,000 ng/μL. The method disclosed in Triplett et al. [46] was also only applicable for the identification of a mixture of pure substances that comprises methamphetamine, which is distinct from the detection of metabolites of methamphetamine in human sweat.

Koh et al. [47] disclosed a wearable surface-enhanced Raman scattering sensor for detecting 2-fluoro-methamphetamine (2-FMA) on human skin. The SERS used a plasmonic silver nanowire layer to enhance the Raman signal. A concentration of 0.5 μg/μL, or 500 ng/μL, was created in a simulated human sweat and applied on human cadaver skin, which was then successfully detected using the wearable SERS sensor. However, this concentration is still relatively high, and may not be representative of the actual concentration of methamphetamine found in the sweat of a drug user.

The greatest challenges in commercializing SERS detection of molecules are: 1) achieving a high detection sensitivity; 2) repeatability of different batches of the colloids; and 3) stability of the colloids, i.e. their properties maintain the same for a reasonable period of at least a few months. All above three goals often conflict with each other and require a delicate balance in choosing synthesizing chemicals; this is the prime reason that there are not many commercialized SERS technology so far.

In addition, sweat contains a large amount of minerals, metabolites, and water; the concentration of the different molecules in the metabolites are extremely low. On top of it, sweat composition is complex, and detection directly on sweat usually yields very weak Raman signal and/or large amount of noise, thus again requiring the detection method to be highly sensitive. Historically, to overcome the detection sensitivity issue, sample purification (e.g. liquid chromatography) was used prior to performing a SERS detection. There exists a need to develop an instrumentation, as well as a method for producing nanoparticles for use in SERS, which can overcome the above issues in commercialization, in addition to being capable of directly detecting molecules from a sample of sweat or other body fluids without the need for sample purification.

### SUMMARY OF THE INVENTION

The present invention provides a novel SERS detection method and apparatuses for chemicals detection of human body through the sweats collected on fingerprints. The method allows the detection to be performed in a rapid, real-time, on-site, and economical fashion with a high sensitivity. The present invention further provides the use of SERS in real-time and on-site to detect methamphetamine through collected fingerprint sweats from methamphetamine misusers. The method exhibits high sensitivity towards methamphetamine, allowing a low methamphetamine concentration of 1 ng/mL to be detected in the fingerprint sweats samples.

The method of the present invention also has applications in bio-medical diagnostics. Using the method, experiments were performed to measure glucose contents in human body through collected fingerprint sweats.

Compared to the existing measurements on other samples such as blood, urine, hair, the measured results in this invention from sweat demonstrate compelling advantages of high accuracy, non-invasiveness, real-time, low-cost, minimum sample preparation, and suitability of the on-site use.

In one embodiment, this invention provides a method for synthesis of gold nanoparticles dispersed in solution, comprising the steps of: (1) mixing a sodium citrate solution and a first chloroauric acid solution to form a first solution, wherein the concentration of sodium citrate of said first solution is 0.05-0.1 M prior to reaction; (2) dilute said first solution with purified water, then mixing the diluted solution with a hydroxylammonium chloride solution to form a second solution, wherein the concentration of gold ions of said second solution is 0.08-0.2 M and the concentration of hydroxylammonium chloride of said second solution is 0.05-0.2 M prior to reaction; (3) preparing a third solution by adding a second chloroauric acid solution to said second solution; (4) preparing a fourth solution by adding a metal hydroxide solution to said third solution, wherein the concentration of metal hydroxide of the fourth solution is 0.5-2 M prior to reaction; and (5) adding an alcohol into said fourth solution to form said gold nanoparticles dispersed in solution; wherein 80% of said gold nanoparticles have a diameter between 25 nm to 40 nm.

In one embodiment, this invention provides a method for detecting a substance directly from a sample of body fluid with SERS using said gold nanoparticles dispersed in solution of claim 1, comprising the steps of: (1) contacting a surface with said sample to be tested; (2) dispensing said gold nanoparticles dispersed in solution onto said surface to form one or more liquid droplets; (3) dispensing an aggregating agent to said one or more liquid droplets; (4) irradiating said one or more liquid droplets with a Raman laser; (5) collecting and analyzing signals from said one or more liquid droplets with a spectra meter; and (6) identifying the existence of the chemical substances from the signals with an algorithm.

In one embodiment, this invention provides a system for on-site detection of a substance directly from a sample of body fluid with SERS, comprising: (1) a surface for contacting said sample; (2) the gold nanoparticles dispersed in solution of claim 1, to be dispensed onto said surface to form one or more liquid droplets; (3) an aggregating agent to be dispersed to said one or more liquid droplets; (4) a portable Raman spectrometer for: a. irradiating a Raman laser onto said one or more liquid droplets; and b. collecting signals from said one or more liquid droplets; and (5) a software program with an algorithm to identify said substance from said signals.

### BRIEF DESCRIPTION OF THE DRAWINGS

FIG. 1 shows the instrumentation for a molecule detection kit in an embodiment of the present invention.

FIG. 2 shows a flow chart for the method of using SERS to detect the concentration of molecules in a sample.

FIG. 3 shows the SERS spectra of pure methamphetamine samples of different concentrations.

FIG. 4 shows the SERS spectra of methamphetamine samples of different concentrations, on dried fingerprint sweat.

FIG. 5 shows the typical SERS signals for (a) a drug addict and (b) a non-addict.

FIG. 6 shows the comparison of SERS signals for between different (a) drug addicts and (b) non-drug addicts. The concentration of methamphetamine in the sweat sample of the drug addicts are (i) 0.17 ng/mL, (ii) 0.24 ng/mL and (iii) 0.29 ng/mL respectively.

### DETAILED DESCRIPTION OF THE INVENTION

The following description of certain embodiment(s) is merely exemplary in nature and is in no way intended to limit the scope of the invention, its applications, or uses.

The gold colloid synthesizing method of the present invention differs from others in that it involves the following:
1. The use of more than one stabilization agents.
2. A separate reduction agent and a separate stabilization agent. Historically, one single chemical was often used for both a reduction and a stabilization agent.
3. Optimized synthesizing process. For each step in the process, we optimized the conditions in the chemical reactions.

The present invention provides a method for the synthesis of gold nanoparticles dispersed in solution. In one embodiment, the method comprises the steps of: (1) mixing a sodium citrate solution and a first chloroauric acid solution to form a first solution, wherein the concentration of sodium citrate of said first solution is 0.05-0.1 M prior to reaction; (2) dilute said first solution with purified water, then mixing the diluted solution with a hydroxylammonium chloride solution to form a second solution, wherein the concentration of gold ions of said second solution is 0.08-0.2 M and the concentration of hydroxylammonium chloride of said second solution is 0.05-0.2 M prior to reaction; (3) preparing a third solution by adding a second chloroauric acid solution to said second solution; (4) preparing a fourth solution by adding a metal hydroxide solution to said third solution, wherein the concentration of metal hydroxide of the fourth solution is 0.5-2 M prior to reaction; and (5) adding an alcohol into said fourth solution to form said gold nanoparticles dispersed in solution; wherein 80% of the gold nanoparticles have a diameter between 25 nm to 40 nm.

In one embodiment, the concentration of sodium citrate of said first solution is 0.05 M, 0.06 M, 0.07 M, 0.08 M, 0.09 M or 0.10 M prior to reaction.

In one embodiment, the concentration of gold ions of said second solution is 0.08 M, 0.10 M, 0.12 M, 0.14 M, 0.16 M, 0.18 M or 0.20 M prior to reaction.

In one embodiment, the concentration of hydroxylammonium chloride of said second solution is 0.1-0.15 M prior to reaction. In one embodiment, the concentration of hydroxylammonium chloride of said second solution is 0.10 M, 0.11 M, 0.12 M, 0.13 M, 0.14 M or 0.15 M prior to reaction.

In one embodiment, the concentration of metal hydroxide of the fourth solution is 1.0-1.5 M prior to reaction. In one embodiment, the concentration of metal hydroxide of the fourth solution is 1.0 M. 1.1 M, 1.2 M, 1.3 M, 1.4 M or 1.5 M prior to reaction.

In one embodiment, the sodium citrate solution of step (1) is heated to 60-90° C.

In one embodiment, the sodium citrate solution of step (1) is heated to 60° C., 70° C., 80° C. or 90° C.

In one embodiment, first chloroauric acid solution of step (1) is heated to 100° C.

In one embodiment, first solution is first heated and then cooled before step (2).

In one embodiment, fourth solution is allowed to react until no further change in color before step (5).

In one embodiment, step (1) comprises: (i) Mixing 1 mL of 1M sodium citrate with 19 mL purified water and heating to 80° C.; (ii) Mixing 250 mL of 0.1M chloroauric acid with 50 mL purified water and heating to 100° C.; (iii) Adding 2.5 mL of said sodium citrate solution of step (i) into said chloroauric acid solution of step (ii); (iv) Heating the mixture of step (iii) to 100° C. for 5 minutes while stirring; and (v) Shaking the mixture of step (iv) with a shaker at 150RPM while cooling the liquid to room temperature to form said first solution.

In one embodiment, step (2) comprises: (a) Adding purified water to said first solution to 50 mL to form a diluted first solution; (b) Mixing 50 mL purified water with 2.5 mL-10 mL of said diluted first solution in a new flask; and (c) Adding 1-3 mL 0.1M hydroxylammonium chloride into said new flask to form said second solution.

In one embodiment, step (3) comprises adding 250 uL of said second chloroauric acid solution to said second solution while shaking to form said third solution.

In one embodiment, step (4) comprises adding 100-600 mL of 1M sodium hydroxide or potassium hydroxide to said third solution while shaking to form said fourth solution.

In one embodiment, the metal hydroxide is selected from the group consisting of sodium hydroxide and potassium hydroxide.

In one embodiment, the alcohol comprises one or more alcohols selected from the group consisting of polyethylene glycol, ethylene glycol and diethylene glycol.

The present invention also provides a method for detecting a substance directly from a sample of body fluid with SERS using the gold nanoparticles dispersed in solution according to an embodiment of the present invention. In one embodiment, the method comprises the steps of: (1) contacting a surface with said sample to be tested; (2) dispensing said gold nanoparticles dispersed in solution onto said surface to form one or more liquid droplets; (3) adding an aggregating agent to said one or more liquid droplets; (4) irradiating said one or more liquid droplets with a Raman laser; and (5) collecting and analyzing signals from said one or more liquid droplets with a spectra meter; (6) identifying existence of said substances from the signals with an algorithm.

In one embodiment, sample is contacted with said surface by pressing a finger onto the surface.

In one embodiment, said surface is a surface on an aluminum foil.

In one embodiment, said aggregating agent is selected from the group consisting of sodium chloride, sodium sulfate, sodium nitrate, potassium chloride, potassium sulfate, potassium nitrate, lithium bromide, and lithium iodide.

In one embodiment, the substance is selected from the group consisting of methamphetamine, cocaine, heroin, glucose and nicotine.

In one embodiment, the body fluid is sweat.

In one embodiment, the Raman laser is a Raman laser from a Raman spectroscopy instrument.

In one embodiment, the Raman spectroscopy instrument is a portable spectrometer.

In one embodiment, the methamphetamine is at a concentration of 0.17-0.25 ng/mL.

In one embodiment, the methamphetamine is at a concentration of greater than 0.17 ng/mL.

In another embodiment, the methamphetamine is at a concentration of greater than 0.20 ng/mL. In one embodiment, the methamphetamine is at a concentration of greater than 0.25 ng/mL. In yet another embodiment, the methamphetamine is at a concentration of 0.20 ng/mL.

The present invention further provides a system for on-site detection of a substance directly from a sample of body fluid with SERS. In one embodiment, the system comprises: (1) a surface for contacting said sample; (2) the gold nanoparticles dispersed in solution according to an embodiment of the present invention, to be dispensed onto said surface to form one or more liquid droplets; (3) an aggregating agent to be dispensed to said one or more liquid droplets; and (4) a portable Raman spectrometer for: (a) irradiating a Raman laser onto said one or more liquid droplets; and (b) collecting signals from said one or more liquid droplets; and (5) a software with an algorithm to identify said substance from said signals.

In one embodiment, said surface for contacting said sample is on an aluminum foil.

In one embodiment, the system further comprises an algorithm for analyzing said signals to identify the presence of said substance in said sample.

In one embodiment, the substance is selected from the group consisting of methamphetamine, cocaine, heroin, glucose and nicotine.

In one embodiment, the body fluid is sweat.

In one embodiment, the particle properties of the gold nanoparticles dispersed in solution synthesized by a method in an embodiment of the present invention do not significantly change within 2-3 months. In one embodiment, the particle properties comprise size, aggregation and sedimentation.

In one embodiment, the gold nanoparticles are capable of amplifying a SERS peak corresponding to a substance.

The invention will be better understood by reference to the Examples which follow, but those skilled in the art will readily appreciate that the specific examples are for illustrative purposes only and should not limit the scope of the invention which is defined by the claims which follow thereafter.

It is to be noted that the transitional term “comprising”, which is synonymous with “including”, “containing” or “characterized by”, is inclusive or open-ended and does not exclude additional, unrecited elements or method steps.

### Example 1

Methods and Materials

Raman Spectroscopy Instrument

A portable spectrometer, EZRaman-A, was supplied by Enwave Optronics Inc. (Irvine Calif.) with a maximum laser power of 200-300 mW at a central wavelength of 785 nm.

Sweat Fingerprint

Thumbs were thoroughly cleaned by commercial Alcohol swipes, and then wait at least 5 minutes before thumbs were pressed firmly onto clean aluminum plates of 5 cm×5 cm.

2 mL of gold NPs colloids liquid was dispensed onto the fingerprints area on the aluminum plates. The aluminum plates were then irradiated by the Raman laser, and signals were collected by photodiode. The laser spots shall be focused onto the middle of the liquid droplets.

Measurements and Data Analysis

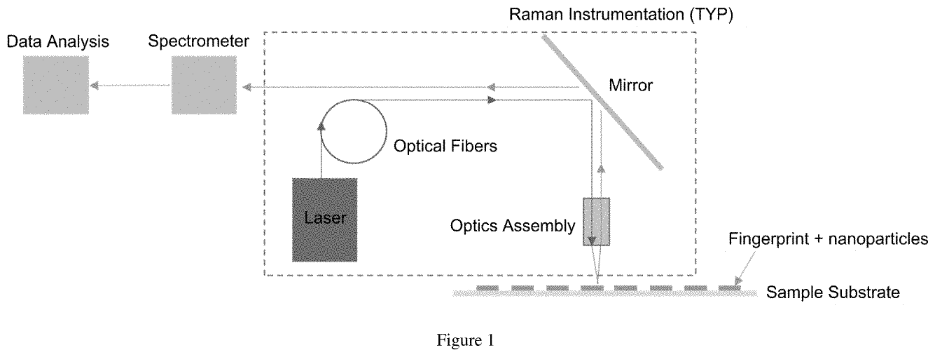

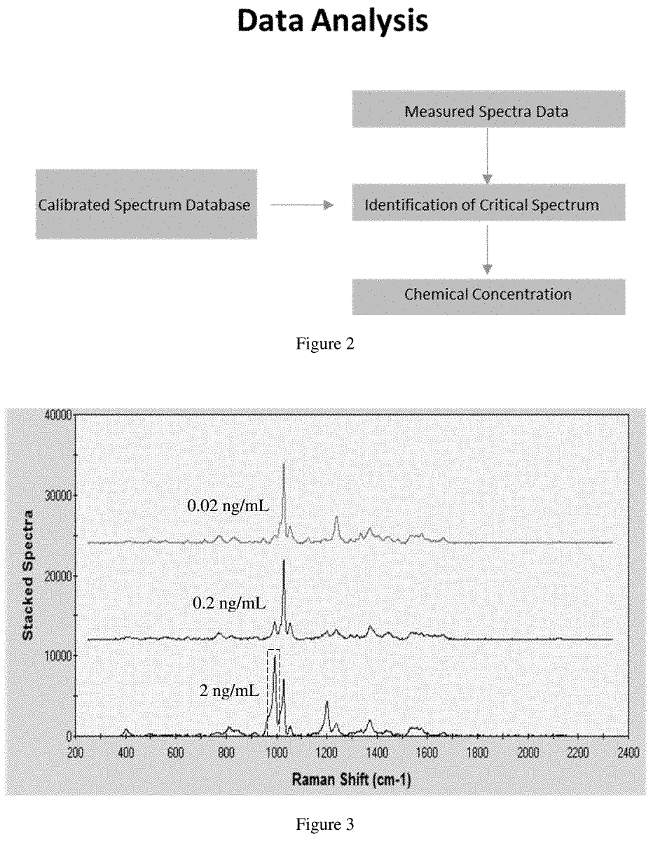

Raman signals were processed using a commercial software program, ComponentOne Chart 2D, Version 8.0, Copyrighted by ComponentOne LLC. The overall instrumentation is illustrated in FIG. 1.

### Example 2

Synthesis of Gold Nanoparticles

The gold nanoparticles dispersed in a solution are synthesized by the following method, comprising the steps of: (1) preparing a sodium citrate solution of concentration between 0.05-0.1 M and heating to 60-90° C.; (2) preparing a first chloroauric acid solution of concentration between 0.8-1 M and heating to 60-100° C.; (3) mixing 2.5 mL of said sodium citrate solution and the said first chloroauric acid solution to form a first solution; (4) heating said first solution at 60-100° C.; (5) preparing a second solution by diluting said first solution with purified water at a volume ratio between 1:20-1:5, and mixing 30 mL to 60 mL of said second solution with 1-3 mL of hydroxylammonium chloride of concentration between 0.1-0.5 M; (6) preparing a third solution by adding 100 uL to 300 uL of a second chloroauric acid solution to said second solution with shaking; (7) preparing a fourth solution by adding 100-600 mL of a metal hydroxide of 0.5-2 M to said third solution; (8) adding 1-3 mL of an alcohol into said fourth solution.

In one embodiment, said metal hydroxide is sodium hydroxide or potassium hydroxide.

In one embodiment, said alcohol is Polyethylene glycol.

### Example 3

Calibration of SERS Signal of Methamphetamine

Experiments of SERS signal of pure methamphetamine were carried out, to identify the SERS detection limit and characteristic Raman spectra. Through these experiments, the diagnosis limit of methamphetamine by SERS using the gold nanoparticles of the present invention can be determined. The wavenumber to identify the methamphetamine from Raman spectrum is at 994 cm-1, highlighted in the dotted box in FIG. 3.

Three SERS spectrum were demonstrated in FIG. 3, corresponding to three different pure methamphetamine concentrations: 2 ng/mL, 0.2 ng/mL, and 0.02 ng/mL. The wavenumber from SERS spectrum to identify methamphetamine is 994 cm-1. At a concentration of 2 ng/mL, there is a large spike at the 994 cm-1, while this peak becomes less pronounced, though still discernible, at a concentration of 0.2 ng/mL. However, at a concentration of 0.02 ng/mL, we cannot see this peak at all from the spectra. Through this experiment, we conclude that the limiting concentration to identify methamphetamine by SERS is about 0.2 ng/mL.

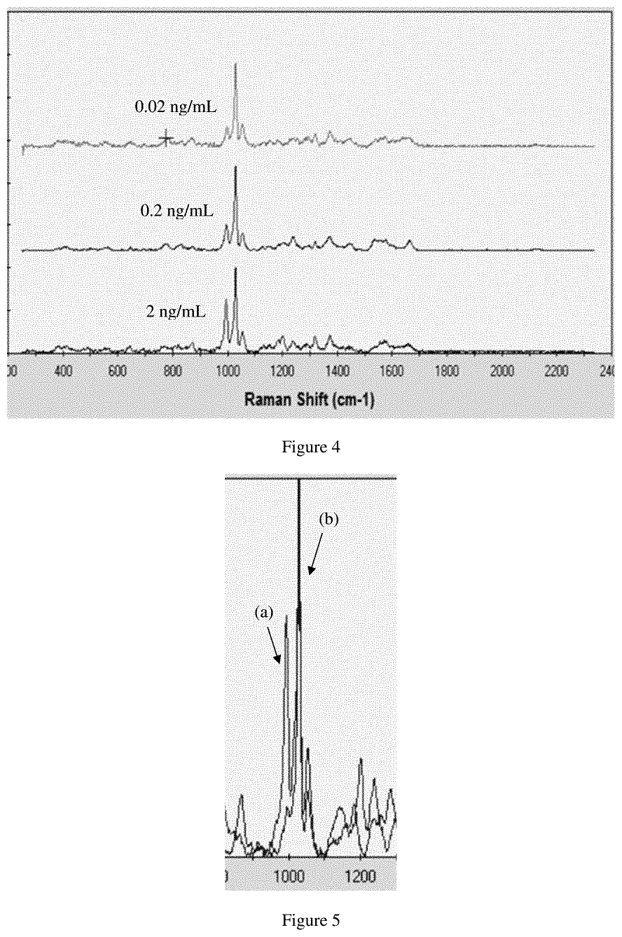

Similar experiments were performed on the methamphetamine mixed with fingerprint sweats of non-addicts. Fingerprint of non-addict were pressed onto aluminum foil; methamphetamine mixed with gold nano-particle liquid at various concentrations (0.02, 0.2, and 2 ng/mL) were then deposited onto the same spots of the fingerprints. Raman laser beams were irradiated into the liquid. The spectrum is presented in FIG. 4. It is shown that at a methamphetamine concentration of 0.2 ng/mL, there is strong signal at the wavenumber of 994 cm-1. These experiments demonstrated that the biological molecules of the sweat from non-addict do not extinguish or reduce the Raman signal from methamphetamine.

FIG. 5 presents typical SERS signals from drug addict and non-addict through fingerprint sweat detection, for a comparison purpose. It clearly demonstrates a spike at 994 cm-1 for a drug addict.

Thus, it is concluded that the detection limit of methamphetamine using SERS with the gold nanoparticles of the present invention is about 0.2 ng/mL, by detecting the spectra at 994 cm-1.

### Example 4

On-site Methamphetamine Detection Through SERS and UDS

Fingerprint sweats of thirty-two (32) drug misuse suspects, collected at entertainment facilities, were used as samples to carry out methamphetamine detection/screening using SERS with the gold nanoparticles of the present invention. In the meantime, urine samples from the same suspects were also collected for urine drug screen (UDS).

The urine screening shows positive for all suspects, indicating the misuse of methamphetamine by all suspects, even though, the readout from two (2) samples, out of all 32, were interpreted as weakly positive. These weakly positive results could be due to: adulterated urine samples; low amount of in-take of methamphetamine by suspects; time delay from in-take of methamphetamine to the test.

The SERS detection of methamphetamine shows twenty-four (24) positive; in addition, there are 5 test results where the spectrum is weak, though positive. The SERS detection also shows two (2) negative results. Note that there is one contaminated fingerprint sample, not allowing proper SERS detection.

If benchmarking against UDS, the SERS detection has an accuracy rate of 93%. This accurate rate is believed to be sufficient to serve a purpose for a rapid, on-site drug screening.

### Example 5

Methamphetamine Detection Through SERS

Due to the uncertainty involved in the UDS, testing of fingerprint sweat using mass spectroscopy (MS) was performed and compared against the SERS results.

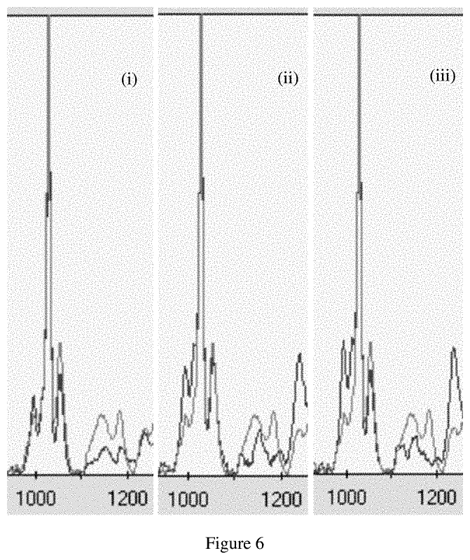

As shown in FIG. 6, it was found that at a methamphetamine concentration between 0.17-0.25 ng/mL, which was detected through MS testing, SERS spectrum have rather small peaks at 994 cm-1. This indicate a low dosage of methamphetamine misuse. At a methamphetamine concentration above 0.25 ng/mL, the spectra peak at 994 cm-1 is very pronounced.

These experiments indicate a strong correlation between the methamphetamine concentration in the sample and the SERS signal at 994 cm-1.

### REFERENCES

[1] Le Ru, E. C.; Etchegoin, P. G. Quantifying SERS enhancements. MRS Bull. 2013, 38, 631-640.
[2] Moskovits, M. Surface roughness and the enhanced intensity of Raman scattering by molecules adsorbed on metals. J. Chem. Phys. 1978, 69, 4159-4161.
[3] Kneipp, K.;Wang, Y.; Kneipp, H.; Perelman, L. T.; Itzkan, I.; Dasari, R. R.; Feld, M. S. Single Molecule Detection Using Surface-Enhanced Raman Scattering (SERS). Phys. Rev. Lett. 1997, 78, 1667-1670.
[4] Pilot, R. et al., A Review on Surface-Enhanced Raman Scattering, Biosensors, 2019, 9, 57.
[5] Eberhardt, K.; Stiebing, C.; Matthaus, C.; Schmitt, M.; Popp, J. Advantages and limitations of Raman spectroscopy for molecular diagnostics: An update. Expert Rev. Mol. Diagn. 2015, 15, 773-787
[6] Judith Langer, et al., Present and Future of Surface-Enhanced Raman Scattering. ACS Nano. 2020, 14, 28-117
[7] Fateixa, S.; Nogueira, H. I. S.; Trindade, T. Hybrid nanostructures for SERS: Materials development and chemical detection. Phys. Chem. Chem. Phys. 2015, 17, 21046-21071.
[8] Ros, I.; Placido, T.; Amendola, V.; Marinzi, C.; Manfredi, N.; Comparelli, R.; Striccoli, M.; Agostiano, A.; Abbotto, A.; Pedron, D.; et al. SERS Properties of Gold Nanorods at Resonance with Molecular, Transverse, and Longitudinal Plasmon Excitations. Plasmonics 2014, 9, 581-593.
[9] Halas, N.J.; Lal, S.; Link, S.; Chang, W. S.; Natelson, D.; Hafner, J. H.; Nordlander, P. A plethora of plasmonics from the laboratory for nanophotonics at Rice University. Adv. Mater. 2012, 24, 4842-4877.
[10] Lohse, S. E.; Murphy, C. J. The quest for shape control: A history of gold nanorod synthesis. Chem. Mater. 2013, 25, 1250-1261.
[11] Xia, Y.; Gilroy, K. D.; Peng, H. C.; Xia, X. Seed-Mediated Growth of Colloidal Metal Nanocrystals. Angew. Chem. Int. Ed. 2017, 56, 60-95.
[12] Lohse, S. E.; Burrows, N. D.; Scarabelli, L.; Liz-Marzin, L. M.; Murphy, C. J. Anisotropic noble metal nanocrystal growth: The role of halides. Chem. Mater. 2014, 26, 34-43.
[13] Dreaden, E. C.; Alkilany, A. M.; Huang, X.; Murphy, C. J.; El-Sayed, M. A. The golden age: Gold nanoparticles for biomedicine. Chem. Soc. Rev. 2012, 41, 2740-2779.
[14] Sun, Y.; Xia, Y. Shape-Controlled Synthesis of Gold and Silver Nanoparticles. Science 2002, 298, 2176-2179. 316. Xia, Y.; Xiong, Y.; Lim, B.; Skrabalak, S. E. Shape-controlled synthesis of metal nanocrystals: Simple chemistry meets complex physics? Angew. Chem. Int. Ed. 2009, 48, 60-103.
[15] Indrasekara, A.S.D.S.; Meyers, S.; Shubeita, S.; Feldman, L. C.; Gustafsson, T.; Fabris, L. Gold nanostar substrates for SERS-based chemical sensing in the femtomolar regime. Nanoscale 2014, 6, 8891-8899.
[16] Rycenga, M.; Cobley, C. M.; Zeng, J.; Li, W.; Moran, C. H.; Zhang, Q.; Qin, D.; Xia, Y. Controlling the synthesis and assembly of silver nanostructures for plasmonic applications. Chem. Rev. 2011, 111, 3669-3712.
[17] Wiley, B.; Sun, Y.; Xia, Y. Synthesis of silver nanostructures with controlled shapes and properties. Ace. Chem. Res. 2007, 40, 1067-1076.
[18] Poletti, A.; Fracasso, G.; Conti, G.; Pilot, R.; Amendola, V. Laser generated gold nanocorals with broadband plasmon absorption for photothermal applications. Nanoscale 2015, 7, 13702-13714. 321. Burda, C.; Chen, X.; Narayanan, R.; El-Sayed, M. A. Chemistry and Properties of Nanocrystals of Di_erent Shapes. Chem. Rev. 2005, 105, 1025-1102.
[19] Turkevich, J.; Stevenson, P. C.; Hillier, J. The formation of colloidal gold. J. Phys. Chem. 1953, 57, 670-673.
[20] Lee, P. C.; Meisel, D. Adsorption and Surface-Enhanced Raman of Dyes on Silver and Gold Sols. J. Phys. Chem. 1982, 86, 3391-3395.
[21] Giallongo, G.; Pilot, R.; Durante, C.; Rizzi, G. A.; Signorini, R.; Bozio, R.; Gennaro, A.; Granozzi, G. Silver Nanoparticle Arrays on a DVD-Derived Template: An easy&cheap SERS Substrate. Plasmonics 2011, 6, 725-733.
[22] Hu, M.; Ou, F. S.; Wu,W.; Naumov, I.; Li, X.; Bratkovsky, A. M.; Williams, R. S.; Li, Z. Gold nanofingers for molecule trapping and detection. J. Am. Chem. Soc. 2010, 132, 12820-12822.
[23] Ou, F. S.; Hu, M.; Naumov, I.; Kim, A.; Wu, W.; Bratkovsky, A. M.; Li, X.; Williams, R. S.; Li, Z. Hot-spot engineering in polygonal nanofinger assemblies for surface enhanced Raman spectroscopy. Nano Lett. 2011, 11, 2538-2542.
[24] Tantra, R.; Brown, R. J. C.; Milton, M. J. T. Strategy to improve the reproducibility of colloidal SERS. J. Raman Spectrosc. 2007, 38, 1469-1479.
[25] Meyer, M.; Le Ru, E. C.; Etchegoin, P. G. Self-limiting aggregation leads to long-lived metastable clusters in colloidal solutions. J. Phys. Chem. B 2006, 110, 6040-6047.
[26] Zheng, J.; He, L. Surface-Enhanced Raman Spectroscopy for the Chemical Analysis of Food. Compr. Rev. Food Sci. Food Saf. 2014, 13, 317-328.
[27] Peksa, V.; Jahn, M.; Stolcova, L.; Schulz, V.; Proska, J.; Prochazka, M.; Weber, K.; Cialla-May, D.; Popp, J. Quantitative SERS analysis of azorubine (E 122) in sweet drinks. Anal. Chem. 2015, 87, 2840-2844.
[28] Cheung, W.; Shadi, I. T.; Xu, Y.; Goodacre, R. Quantitative analysis of the banned food dye sudan-1 using surface enhanced raman scattering with multivariate chemometrics. J. Phys. Chem. C 2010, 114, 7285-7290.
[29] Pilot, R. SERS detection of food contaminants by means of portable Raman instruments. J. Raman Spectroscopy. 2018, 49, 954-981.
[30] Hakonen, A.; Rindzevicius, T.; Schmidt, M. S.; Andersson, P. O.; Juhlin, L.; Svedendahl, M.; Boisen, A.; Kall, M. Detection of nerve gases using surface-enhanced Raman scattering substrates with high droplet adhesion. Nanoscale 2016, 8, 1305-1308.
[31] Fikiet, M. A.; Khandasammy, S. R.; Mistek, E.; Ahmed, Y.; Halimkovi, L.; Bueno, J.; Lednev, I. K. Surface enhanced Raman spectroscopy: A review of recent applications in forensic science. Spectrochim. Acta Part A Mol. Biomol. Spectrosc. 2018, 197, 255-260.
[32] Dong, J. C.; Zhang, X. G.; Briega-Martos, V.; Jin, X.; Yang, J.; Chen, S.; Yang, Z. L.; Wu, D. Y.; Feliu, J. M.; Williams, C. T.; et al. In situ Raman spectroscopic evidence for oxygen reduction reaction intermediates at platinum single-crystal surfaces. Nat. Energy 2019, 4, 60-67.
[33] Xie, W.;Walkenfort, B.; Schlucker, S. Label-free SERS monitoring of chemical reactions catalyzed by small gold nanoparticles using 3D plasmonic superstructures. J. Am. Chem. Soc. 2013, 135, 1657-1660.
[34] Mamian-Lopez, M. B.; Poppi, R., Standard addition method applied to the urinary quantification of nicotine in the presence of cotinine and anabasine using surface enhanced Raman spectroscopy and multivariate curve resolution, Analytica Chimica Acta, 2013, 760, 53-59
[35] Ya-Chuan Kao, Xuemei Han, Yih Hong Lee, Hiang Kwee Lee, Gia Chuong Phan-Quang, Multiplex Surface-Enhanced Raman Scattering Identification and Quantification of Urine Metabolites in Patient Samples within 30 min, ACS Nano, 2020, 14, 2542-2552
[36] Duo Lin, Jianji Pan, Hao Huang, Guannan Chen, Sufang Qiu, Hong Shi, Weiwei Chen, Yun Yu, Shangyuan Feng, Rong Chen, Label-free blood plasma test based on surface-enhanced Raman scattering for tumor stages detection in nasopharyngeal cancer, Sci Rep. 2014 234, 4751
[37] K. Sato,W. H. Kang, K. Saga, and K. T. Sato, “Biology of sweat glands and their disorders. I. Normal sweat gland function,” Journal of the American Academy of Dermatology, vol. 20, no. 4, pp. 537-563, 1989.
[38] M. M. Raiszadeh, M. M. Ross, P. S. Russo et al., “Proteomic analysis of eccrine sweat: implications for the discovery of schizophrenia biomarker proteins,” Journal of Proteome Research, vol. 11, no. 4, pp. 2127-2139, 2012
[39] Y. H. Caplan and B. A. Goldberger, “Alternative specimens for workplace drug testing,” Journal of Analytical Toxicology, vol. 25, no. 5, pp. 396-399, 2001.
[40] S. Jadoon, S. Karim, et. al, “Recent Developments in Sweat Analysis and Its Applications”, Int J Anal Chem. 2015, 164974
[41] N. Samyn and C. van Haeren, “On-site testing of saliva and sweat with drugwipe and determination of concentrations of drugs of abuse in saliva, plasma and urine of suspected users,” International Journal of Legal Medicine, vol. 113, no. 3, pp. 150-154, 2000.
[42] R. Torre and S. Pichini, “Usefulness of Sweat Testing for the Detection of Cannabis Smoke”, Clinical Chemistry, Vol 50, 11, 1961-1962
[43] M. Hudson, T. Stuchinskya, S. Rmma, et. al., “Drug screening using the sweat of a fingerprint: lateral flow detection of A9-tetrahydrocannabinol, cocaine, opiates, and amphetamine”, 2019, 43, 88-95
[44] P Kintz 1, A Tracqui, P Mangin, Y Edel, “Sweat testing in opioid users with a sweat patch”, J Anal Toxicol, 1996, 20, 393-397.
[45] N Itoh, S E J Bell, “High dilution surface-enhanced Raman spectroscopy for rapid determination of nicotine in e-liquids for electronic cigarettes”, Analyst, 2017, 142, 994
[46] J. S. Triplett and M. R. David, “Raman Spectroscopy with Multi-component Searching for Complex Clandestine Laboratory Sample Analysis (I), Raman Spectroscopy as a Rapid, Non-destructive Screening Test for Methamphetamine in Clandestine Laboratory Liquids (II), and Raman Spectroscopy for Enhanced Synthetic Cathinone Analysis (III)”, NIJ-Sponsored, 2014, NCJ 248557.
[47] Eun Hye Koh, Won-Chul Lee, Yeong-Jin Choi et al., “A Wearable Surface-Enhanced Raman Scattering Sensor for Label-Free Molecular Detection”, ACS Appl. Mater. Interfaces, 2021, 13, 3024-3032.

What is claimed is:

1. A method for synthesis of gold nanoparticles dispersed in solution, comprising the steps of:
(1) mixing a sodium citrate solution and a first chloroauric acid solution to form a first solution, wherein the concentration of sodium citrate of said first solution is 0.05-0.1 M prior to reaction;
(2) dilute said first solution with purified water, then mixing the diluted solution with a hydroxylammonium chloride solution to form a second solution, wherein the concentration of gold ions of said second solution is 0.08-0.2 M and the concentration of hydroxylammonium chloride of said second solution is 0.05-0.2 M prior to reaction;
(3) preparing a third solution by adding a second chloroauric acid solution to said second solution;
(4) preparing a fourth solution by adding a metal hydroxide solution to said third solution, wherein the concentration of metal hydroxide of the fourth solution is 0.5-2 M prior to reaction; and
(5) adding an alcohol into said fourth solution to form said gold nanoparticles dispersed in solution;
wherein 80% of said gold nanoparticles have a diameter between 25 nm to 40 nm.

2. The method of claim 1, wherein said sodium citrate solution of step (1) is heated to 60-90° C.

3. The method of claim 1, wherein said first chloroauric acid solution of step (1) is heated to 100° C.

4. The method of claim 1, wherein said first solution is first heated and then cooled before step (2).

5. The method of claim 1, wherein said fourth solution is allowed to react until no further change in color before step (5).

6. The method of claim 1, wherein said step (1) comprises:
i. Mixing 1 mL of 1M sodium citrate with 19 mL purified water and heating to 80° C.;
ii. Mixing 250 mL of 0.1M chloroauric acid with 50 mL purified water and heating to 100° C.;
iii. Adding 2.5 mL of said sodium citrate solution of step (i) into said chloroauric acid solution of step (ii);
iv. Heating the mixture of step (iii) to 100° C. for 5 minutes while stirring; and
v. Shaking the mixture of step (iv) with a shaker at 150RPM while cooling the liquid to room temperature to form said first solution.

7. The method of claim 6, wherein said step (2) comprises:
a. Adding purified water to said first solution to 50 mL to form a diluted first solution;
b. Mixing 50 mL purified water with 2.5 mL-10 mL of said diluted first solution in a new flask; and
c. Adding 1-3 mL 0.1M hydroxylammonium chloride into said new flask to form said second solution.

8. The method of claim 7, wherein step (3) comprises adding 250 uL of said second chloroauric acid solution to said second solution while shaking to form said third solution.

9. The method of claim 8, wherein step (4) comprises adding 100-600 mL of 1M sodium hydroxide or potassium hydroxide to said third solution while shaking to form said fourth solution.

10. The method of claim 1, wherein said metal hydroxide is selected from the group consisting of sodium hydroxide and potassium hydroxide.

11. The method of claim 1, wherein said alcohol comprises one or more alcohols selected from the group consisting of polyethylene glycol, ethylene glycol and diethylene glycol.

12. A method for detecting a substance directly from a sample of body fluid with SERS using said gold nanoparticles dispersed in solution of claim 1, comprising the steps of:
(1) contacting a surface with said sample to be tested;
(2) dispensing said gold nanoparticles dispersed in solution onto said surface to form one or more liquid droplets;
(3) dispensing an aggregating agent to said one or more liquid droplets;
(4) irradiating said one or more liquid droplets with a Raman laser;
(5) collecting and analyzing signals from said one or more liquid droplets with a spectra meter; and
(6) identifying the existence of the chemical substances from the signals with an algorithm.

13. The method of claim 12, wherein said surface is a surface on an aluminum foil.

14. The method of claim 12, wherein said aggregating agent is selected from the group consisting of sodium chloride, sodium sulfate, sodium nitrate, potassium chloride, potassium sulfate, potassium nitrate, lithium bromide, and lithium iodide.

15. The method of claim 12, wherein said substance is selected from the group consisting of methamphetamine, cocaine, heroin, glucose, and nicotine.

16. The method of claim 12, wherein said body fluid is sweat.

17. The method of claim 12, wherein said Raman laser is a Raman laser from a Raman spectroscopy instrument.

18. The method of claim 12, wherein said methamphetamine is at a concentration of 0.17-0.25 ng/mL.

19. A system for on-site detection of a substance directly from a sample of body fluid with SERS, comprising:
(1) a surface for contacting said sample;
(2) the gold nanoparticles dispersed in solution of claim 1, to be dispensed onto said surface to form one or more liquid droplets;
(3) an aggregating agent to be dispersed to said one or more liquid droplets;
(4) a portable Raman spectrometer for:
a. irradiating a Raman laser onto said one or more liquid droplets; and
b. collecting signals from said one or more liquid droplets; and
(5) a software program with an algorithm to identify said substance from said signals.

20. The system of claim 19, wherein said substance is selected from the group consisting of methamphetamine, cocaine, heroin, glucose and nicotine.

21. The system of claim 19, wherein said body fluid is sweat.
